(19) United States
(12) Patent Application Publication
(10) Pub. No.: US 2019/0279623 A1
(43) Pub. Date: Sep. 12, 2019

(54) METHOD FOR SPEECH RECOGNITION DICTATION AND CORRECTION BY SPELLING INPUT, SYSTEM AND STORAGE MEDIUM

(71) Applicant: KIKA TECH (CAYMAN) HOLDINGS CO., LIMITED, Beijing (CN)

(72) Inventors: Yu LIU, Beijing (CN); Conglei YAO, Beijing (CN); Hao CHEN, Beijing (CN); Chengzhi LI, Beijing (CN); Jingchen SHU, Beijing (CN)

(21) Appl. No.: 15/915,742

(22) Filed: Mar. 8, 2018

(51) Int. Cl. G10L 15/22; G10L 15/18; G10L 15/30

(52) U.S. Cl. CPC G10L 15/22; G10L 2015/088; G10L 15/30; G10L 15/18

(57) ABSTRACT

One aspect of the present disclosure provides a method for speech recognition dictation and correction by spelling input, which is implemented in a system including a terminal. The method includes transforming a speech signal received by the terminal into a speech recognition result. Whether the speech recognition result includes spelling input is determined, and a setting is identified according to a first speech recognition result and the speech recognition result including the spelling input. In response to a correction setting in which the spelling input includes a correction content, the first speech recognition result is modified according to the correction content into an edited speech recognition input, and the edited speech recognition input is displayed on a user interface of the terminal. Accordingly, the speech recognition correction is achieved by spelling input. Another aspect of the present application provides related system and storage medium implementing embodiments of the disclosed method.

### FIELD OF THE DISCLOSURE

The present disclosure relates to the field of speech recognition technologies and, more particularly, relates to a method for speech recognition dictation and correction by spelling input, a system, and a storage medium implementing the method.

### BACKGROUND

With development of speech recognition related technologies, more and more electronic devices are equipped with speech recognition applications to establish another channel of interaction between human and electronic devices.

These conventional speech recognition applications may have some application limitations. For example, in a situation of inputting a speech signal of a specific name, especially a person's name or a geographical name, systems of the conventional speech recognition applications may not be able to identify a correct spelling of the specific name, and accordingly display an incorrect recognition result. In another situation, due to homophone or words with similar pronunciation, frequency of mistakes may increase. Further, when correcting errors, the users are required to delete incorrect words and re-input, the operations of which would dramatically reduce input efficiency.

In light of the above-stated problems, some of the conventional technologies also provide solutions in which, for example, lexical contexts and acoustic features are taken in consideration to distinguish homophone and words with similar pronunciations. However, when the contexts and/or the pronunciations are identical, inaccurate speech recognition may still result. In particular, people's names or geographical names involve a diversity of spelling, for which the systems may not be able to predict correct spelling of those names merely based on speech signals. Also, the users' insertion of correct inputs into the previous result may place contexts in a mess, thereby bringing more errors to cause the systems unreliable.

Accordingly, in view of the above drawbacks, the present disclosure provides a method for speech recognition dictation and correction by spelling input, a system and a storage medium implementing the method.

### BRIEF SUMMARY OF THE DISCLOSURE

The present disclosure provides a method for speech recognition dictation and correction by spelling input, related system and storage medium. The present disclosure is directed to solve at least some of the problems set forth above.

One aspect of the present disclosure provides a method for speech recognition dictation and correction by spelling input, in which a speech recognition result may be corrected by spelling input through speech interaction between human and electronic devices in a manner similar to the way of interpreting and understanding human natural languages.

The present disclosure provides the method for speech recognition dictation and correction by spelling input, implemented in a system that may include a terminal. The method may include transforming a speech signal received by the terminal into a speech recognition result. Whether the speech recognition result includes spelling input may be determined, and a setting may be identified according to a first speech recognition result and the speech recognition result including the spelling input. In response to a correction setting in which the spelling input includes a correction content, the first speech recognition result may be modified according to the correction content into an edited speech recognition input. The edited speech recognition input may be displayed on a user interface of the terminal.

A second aspect of the present disclosure provides a system for speech recognition dictation and recognition by spelling input. The system may include: a server including an Automatic Speech Recognition (ASR) module and a Natural Language Understanding (NLU) module; a terminal including a user interface, a processor. The processor of the terminal may be configured to receive a speech signal and transmit the speech signal to the ASR module of the server. The ASR module may be configured to transform the speech signal into a speech recognition result. The NLU module may be configured to determine whether the speech recognition result includes spelling input and identify a setting according to a first speech recognition result and the speech recognition result including the spelling input. In response to a correction setting in which the spelling input includes a correction content, the NLU module may be configured to modify the first speech recognition result according to the correction content into an edited speech recognition input, and the processor of the terminal may be configured to display the edited speech recognition input on the user interface of the terminal.

A third aspect of the present disclosure provides a non-transitory storage medium for storing computer-executable instructions for execution by a hardware processor of a terminal to receive a speech signal by the terminal, transmit the speech signal to an Automatic Speech Recognition (ASR) module of a server, and cause the ASR module to transform the speech signal into a speech recognition result; cause a Natural Language Understanding (NLU) module of the server to determine whether the speech recognition result includes spelling input, and to identify a setting according to a first speech recognition result and the speech recognition result including the spelling input; and in response to a correction setting in which the spelling input includes a correction content, cause the NLU module to modify the first speech recognition result according to the correction content into an edited speech recognition input; and cause the processor of the terminal to display the edited speech recognition input on a user interface of the terminal.

Through the introduction of the NLU module, corrections may be conducted by spelling input, and the templates required for correction in the conventional skills may be omitted. Accordingly, user inputs can be dramatically enhanced.

### BRIEF DESCRIPTION OF THE DRAWINGS

To more clearly describe the technical solutions in the present disclosure or in the existing technologies, drawings accompanying the description of the embodiments or the existing technologies are briefly described below. Apparently, the drawings described below only show some embodiments of the disclosure. For those skilled in the art, other drawings may be obtained based on these drawings without creative efforts.

FIG. 1 illustrates a flow diagram of a method for speech recognition dictation and correction by spelling input according to one embodiment of the present disclosure;

FIGS. 2a to 2d illustrate an exemplary user interface of a terminal in a sequence of operations according to one embodiment of the present disclosure;

FIGS. 3a to 3c illustrate an exemplary user interface of a terminal in a sequence of operations according to another embodiment of the present disclosure;

FIG. 4 illustrates a schematic diagram of an exemplary system which implements embodiments of the disclosed method for speech recognition dictation and correction by spelling input;

FIG. 5 is a schematic diagram of an exemplary hardware structure of a terminal according to one embodiment of the present disclosure; and

FIG. 6 is a schematic diagram of an exemplary hardware structure of a Natural Language Understanding (NLU) module.

### DETAILED DESCRIPTION

Reference will now be made in detail to exemplary embodiments of the present disclosure, which are illustrated in the accompanying drawings. Wherever possible, the same reference numbers will be used throughout the drawings to refer to the same or like parts. It is apparent that the described embodiments are some but not all of the embodiments of the present disclosure. Based on the disclosed embodiments, persons of ordinary skill in the art may derive other embodiments consistent with the present disclosure, all of which are within the scope of the present disclosure.

Unless otherwise defined, the terminology used herein to describe the present disclosure is for the purpose of describing particular embodiments only and is not intended to limit the present disclosure. As used herein, the term “and/or” includes any and all combinations of one or more of the associated listed items. The terms of “first”, “second”, “third” and the like in the specification, claims, and drawings of the present disclosure are used to distinguish different elements and not to describe a particular order.

One aspect of the present disclosure provides a method for speech recognition dictation and correction by spelling input, in which a user may apply spelling input to correct a word contained in a previous speech recognition dictation. Embodiments provided by the present disclosure may be implemented as software applications installed on various devices, such as laptop computers, smartphones, smart appliances, etc. Meanwhile, the embodiments of the present disclosure may assist the user in entering input more accurately and efficiently by providing multiple ways of editing and correcting speech recognition results.

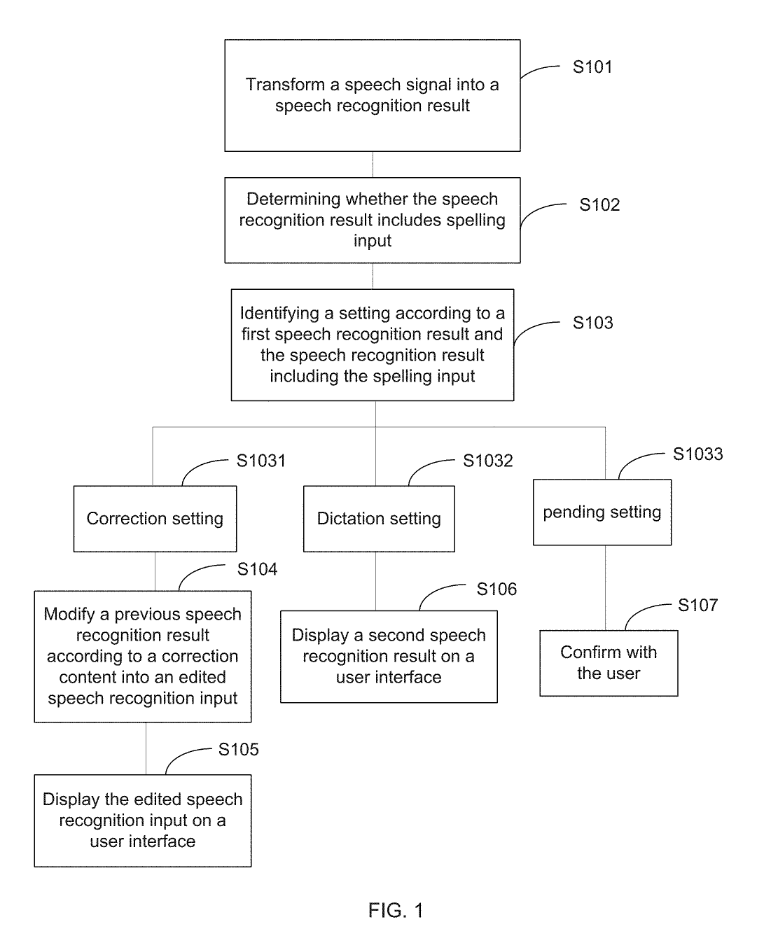

FIG. 1 illustrates a flow diagram of a method for speech recognition dictation and correction by spelling input according to one embodiment of the present disclosure. The disclosed method for speech recognition dictation and correction by spelling input may be implemented in a system environment which includes a terminal and a server, each including at least one processor respectively. That is, the method may be implemented in a system for speech recognition dictation and correction by spelling input.

As shown in FIG. 1, the disclosed method includes the following steps.

Step S101: The system for speech recognition dictation and correction by spelling input may transform a speech signal received by the terminal into a speech recognition result.

The user activates a speech recognition dictation function of the terminal, and inputs the speech signal at the terminal. And the speech signal is received by the processor of the terminal, transmitted to an automatic speech recognition (ASR) module, and processed by the ASR module to transform the speech signal into the speech recognition result. The terminal herein may refer to an electronic device which requires speech recognition dictation and is accordingly configured to receive and process speech signal inputs. For example, the terminal may include a mobile phone, a notebook, a desktop computer, a tablet, or the like. The automatic speech recognition (ASR) module, as the name suggests, is configured to perform speech recognition based on speech signals, and transform the received speech signals into the speech recognition results, preferably, in text format.

In one embodiment, the terminal may be equipped with the ASR module locally. Accordingly, the processor of the terminal may include the ASR module including an application-specific integrated chip (ASIC) for performing the speech recognition. In another example, however, the ASR module may be stored on a server. After the terminal receives the speech signals, the terminal may transmit the speech signals to the server with the ASR module for data processing. Upon completion of the process, the speech recognition result may be generated, transmitted by the service, and then received by the processor of the terminal.

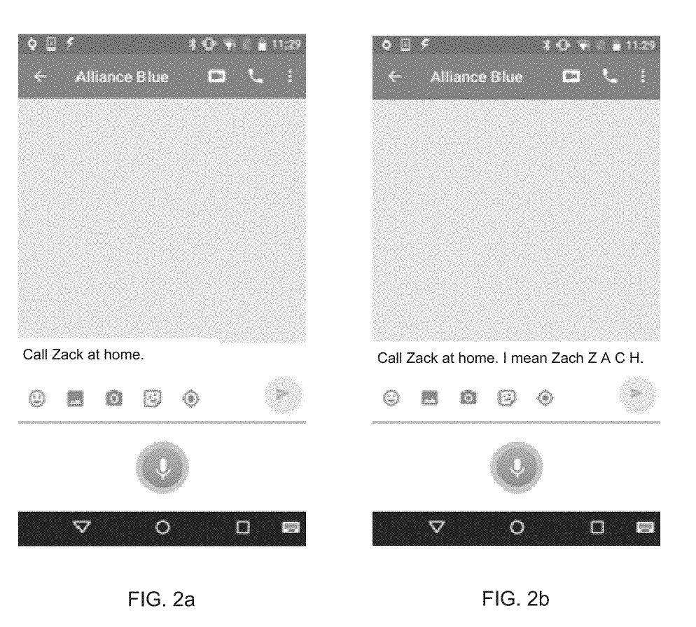

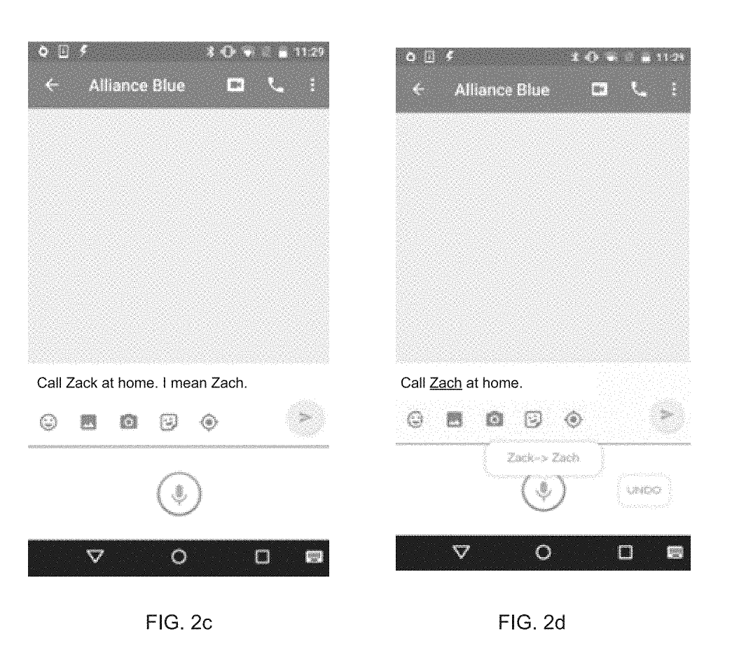

FIGS. 2a-2d illustrate an exemplary user interface of the terminal in a sequence of operations according to one embodiment of the present disclosure. The terminal provides the user interface on which a button of the speech recognition dictation function may be displayed for user to trigger. The user activates the speech recognition dictation function of the system and inputs the speech signal. As shown in FIG. 2a, once the speech recognition result transformed from the speech signal is received, the speech recognition result may be displayed on the user interface of the terminal for the user's review.

Step S102: The system for speech recognition dictation and correction by spelling input may determine whether the speech recognition result includes spelling input.

Upon obtaining the speech recognition result returned from the ASR module, the system may be configured to determine whether the spelling input is contained by inspecting the returned speech recognition result. In one embodiment, the system may determine whether the speech recognition result contains the spelling input by inspecting and/or identifying whether the returned speech recognition result includes a plurality of single letters. Models that show the speech recognition result containing the spelling input may include, but not limited to, a plurality of single letters in addition to a word (e.g., “Z A C H Zach”), a word in addition to a plurality of single letters (e.g., “Zach Z A C H”), and merely a plurality of single letters (e.g., “Z A C H”). By inspecting whether the speech recognition result includes the plurality of single letters, whether the spelling input is contained may be accordingly determined.

In some embodiments, the system further may include a Natural Language Understanding (NLU) module. Natural Language Understanding (NLU) is an artificial intelligence technology to teach and enable a machine to learn, understand, and further remember human languages so as to enable a machine to conduct a direct communication with humans. With the installation of the NLU module, the system may analyze the speech recognition result in a natural language manner to determine whether the spelling input is contained, thereby expanding the applications of the present disclosure. For instance, with the NLU module, the above three models may be expanded to the speech recognition results including “It's Z A C H Zach,” “I mean Zach Z A C H,” and “I said Z A C H,” in a manner similar to understand and interpret human languages. Therefore, the spelling input can be identified more efficiently and accurately.

The NLU module may be built in the processor of the terminal locally. Accordingly, the system can conduct an off-line analysis based on analytical models and/or algorithms established by the NLU module at the terminal. The analytical models may be established such that the NLU module analyzes the speech recognition results in a manner similar to the way of interpreting and understanding human languages, not restricted to certain templates. On the other hand, the NLU module may also be implemented at the server. In that case, the terminal may be configured connect to the server for the analyses conducted by the NLU module via a communication network.

Upon locating the plurality of single letters, in some embodiments, the system may be configured to combine the plurality of single letters to obtain a content, for later correction or later dictation. In the example of FIGS. 2a-2d, in FIG. 2b, the user gives another speech signal “I mean Zach Z A C H” which is transformed into a speech recognition result and displayed on the user interface of the terminal accordingly. Now that the plurality of single letters “Z A C H” is found, the speech recognition result “I mean Zach Z A C H” is identified as containing the spelling input “Z A C H”. Further, the system combines the plurality of single letters “Z A C H” to obtain the content “Zach,” and, according to the content, the system may modify the speech recognition result according to the content “Zach” into a second speech recognition result “I mean Zach”, and display the second speech recognition result on the user interface. For example, as shown in FIG. 2c, the speech recognition result is modified from “I mean Zach Z A C H” to “I mean Zach” according to “Zach.”

Step S103: The system for speech recognition dictation and correction by spelling input may identify a setting according to a first speech recognition result and the speech recognition result including the spelling input.

After the spelling input is found and located in the speech recognition result, the system may be configured to determine and identify the setting according to the first speech recognition result and the current speech recognition result including the spelling input. The first speech recognition result herein may refer to a previous speech recognition result. And more specifically, the first speech recognition result may include the last speech recognition result just prior to the current speech recognition result.

In order to determine the setting, the current speech recognition result including the spelling input is matched with and/or compared to the first speech recognition result. In some embodiments, if the second speech recognition result, the modified speech recognition result according to the content, and the first speech recognition result have a first level of overlapping in contexts, it may imply that the user inputs the current speech recognition result for correction. The “overlapping in contexts” herein may refer to comparing to the first speech recognition result with the current speech recognition result including the spelling input in the contexts, and/or, based on analytical models and/or algorithms, the system analyzes the contexts and judges whether the spelling input is inputted for correction. Under this condition, the system may identify the setting as a correction setting (as shown in step S1031 of FIG. 1). And the content combining from the plurality of single letters is identified as a correction content by the system for later use.

In other embodiments, for ease of use, the system may also provide button options on the user interface for the user to select, and a selection may be fed back to inform the system whether correction or dictation is requested by the user.

In other embodiments, the Natural Language Understanding (NLU) module of the system, as stated, may be configured to perform the setting analyses. The NLU module may include a knowledge database and a history database. The knowledge database is configured to provide analytical models for an input to match with, and, if an analytical result is found, the system may output the result. On the other hand, the history database is configured to store historical data, based on which the analytical models of the knowledge database may be established and expanded. The historical data herein may include previous data analyses. The NLU module may be configured to compare the first speech recognition result with the second speech recognition result, the modified speech recognition result according to the content, based on the built-in analytical models to obtain a first match value and a second match value. The first and second match values can be regarded as a correction match value and a dictation match value, respectively. If the first match value is greater than or equal to a first threshold, and the second match value is less than a second threshold, it may imply that the user intends for correction. Accordingly, it is identified as the correction setting (step S1031).

Further, in some embodiments, if the second speech recognition result and the first speech recognition result have a second level of non-overlapping in the contexts after the comparison, it may imply the user inputs the current speech recognition result merely for dictation. Accordingly, it may be identified as a dictation setting (as shown in step S1032 of FIG. 1). The system may identify the content as a dictation content for later use.

In some embodiments, the NLU module may be configured to obtain the first match value and the second match value. If the first match value is less than the first threshold, and the second match value is greater than the second threshold, it is identified as the dictation setting (as shown in step S1032 of FIG. 1).

There are other cases, such as when the first and second match values are greater than or equal to the first and second thresholds respectively, or the first and second match values are less than the first and second thresholds respectively. These cases may be identified as being in a pending setting (Step S1033), meaning that neither the system is not in the correction setting nor the dictation setting. For instance, if a user inputs that did not have obvious meaning, the system may determine that it is in the pending setting, in which the system doesn't distinguish whether it should be categorized to the correction setting or the dictation setting.

Step S104: In response to the correction setting in which the spelling input includes the correction content, the system may modify the first speech recognition result according to the correction content into an edited speech recognition input.

As the correction setting is identified, the system confirms that the user inputs the current speech recognition result containing the spelling input for correction at a first stage. As mentioned, the correction content is obtained from combining the plurality of single letters.

In the example of FIGS. 2a-2d, after the user realizes that the system mistakenly spelt the person's name from “Zach” to “Zack” as shown in FIG. 2a, he/she may re-activate the speech recognition dictation function of the system, and attempt to correct the error by spelling the person's name. Accordingly, the speech signal “I mean Zach Z A C H” with the spelling input is given. The speech recognition result is displayed on the user interface of the terminal as shown in FIG. 2b. Now that the plurality of single letters “Z A C H” is found, the speech recognition result is identified containing the spelling input. The correction content “Zach” is obtained by combining the plurality of single letters “Z A C H.” In one example as shown in FIG. 2c, the system modifies the current speech recognition result from “I mean Zach Z A C H” into the second speech recognition result “I mean Zach,” according to the correction content “Zach.”

In some embodiments, based on the established analytical models and algorithms, the NLU module of the system may compare the first speech recognition result and the correction content to obtain at least one target. The at least one target herein may refer to a location at which the error should be corrected. In other embodiments, the system may also offer button options for the user to select at least one target for collection. Upon obtaining the at least one target, the system may replace the at least one target of the first speech recognition result with the correction content to form the edited speech recognition input. In one embodiment, the system may be configured to correct not only an error in the previous speech recognition result but also a same error in the current speech recognition result. For example, after the user realizes that an error “Zack” occurs in the previous speech recognition result “Call Zack at home”, he/she may give a new speech signal “I mean Zach Z A C H” to correct the error. However, the system may still spell the person's name mistakenly in the current speech recognition result as “I mean Zack Z A C H.” In that case, after obtaining the correction content “Zach”, the wrong name “Zack” in the previous speech recognition result “Call Zack at home” and in the current speech recognition result “I mean Zack” can both be corrected according to the correction content “Zach.”

Step S105: In response to the correction setting, the system may display the edited speech recognition input on the user interface of the terminal.

As shown in FIG. 2c, the second speech recognition result “I mean Zach”, modified according the correction content “Zach”, is inputted by the user to correct the first speech recognition result “Call Zack at home.” For that reason, the at least one target with which the correction content replaces is being analyzed and obtained by the NLU module. As shown in FIG. 2c, “Zack” in “Call Zack at home” is the target being replaced by the correction content “Zach.”

Upon the first speech recognition result being modified according to the correction content at the at least one target, the edited speech recognition input may be displayed accordingly on the user interface of the terminal. As shown in FIG. 2d, after the system conducts an analysis and obtains the at least one target of the first speech recognition result being “Zack”,” “Zack” in “Call Zack at home” is replaced by the correction content “Zach” to form the edited speech recognition input “Call Zach at home.” In one example, the system may also emphasize the modification, and provide an undo button for the user to reset the change. As shown in FIG. 2d, after the change, “Zach” in “Call Zach at home” is underlined to show that it is the correction content, and the undo button is provided on the user interface. In one example, as shown in FIG. 2d, prior to displaying the edited recognition input “Call Zach at home,” the second speech recognition result “I mean Zach” is removed from the user interface.

Step S106: In response to the dictation setting in which the spelling input includes the dictation content, the system may display the second speech recognition result on the user interface.

In a scenario where the user inputs another speech signal following the first speech recognition result for dictation, it is identified as the dictation setting. In order to identify the dictation setting, as stated above, the first speech recognition result and the second speech recognition result are compared to and/or matched with. The dictation content is formed by combining the plurality of single letters of the spelling input.

In response to the dictation setting, upon the speech recognition result being modified into the second speech recognition result according to the dictation content, the second speech recognition result is accordingly displayed on the user interface of the terminal.

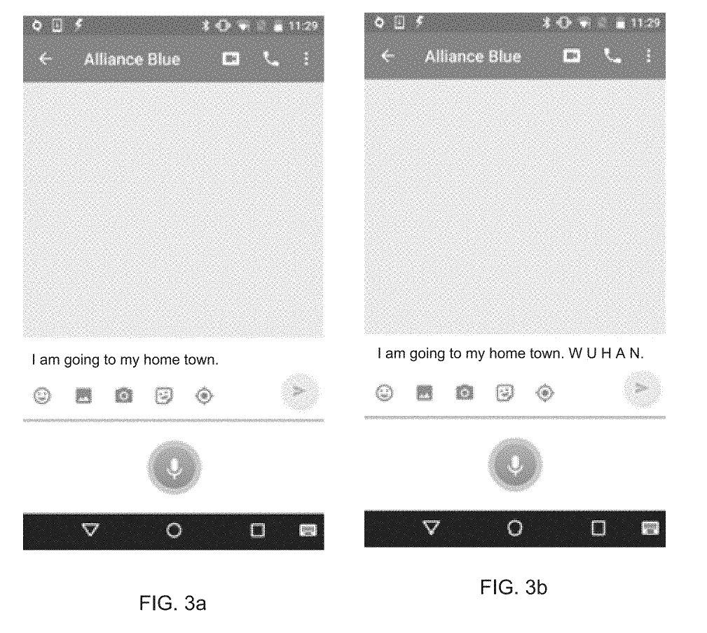

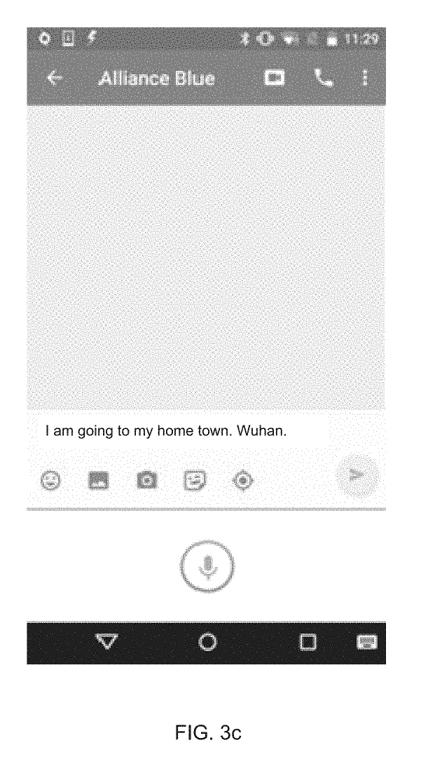

FIGS. 3a to 3c illustrate an exemplary user interface of a terminal in a sequence of operations according to another embodiment of the present disclosure. In FIG. 3a, the first or the previous speech recognition result “I'm going back to my home town” is displayed on the user interface of the terminal. And the user intends to explain what he/she means by saying “home town”, and gives another speech signal. Accordingly, as shown in FIG. 3b, a speech recognition result including the spelling input “W U H A N” is transformed from the speech signal. The spelling input “W U H A N” is combined to form the content “Wuhan.” The NLU module of the system may compare the first speech recognition result “I'm going to my home town” with the second speech recognition result after the combination “Wuhan” based on the analytical models to determine it is the dictation setting, in which the user gives the current speech signal for dictation. Therefore, the system identifies the content “Wuhan” as the dictation content. The second speech recognition result is obtained according to the dictation content “Wuhan.” Accordingly, as shown in FIG. 3c, the second speech recognition result “Wuhan” is displayed following the first or previous speech recognition result “I'm going back to my home town” for explanation.

Step S107: In response to the pending setting, the system may confirm with the user about whether correction or dictation is required.

In the corner cases where neither the correction setting nor the dictation setting can be identified, it may be identified as the pending setting. For the pending setting in which the system does not know what the user intends for, in order to prevent from another mistake, the system may confirm with the user about his/her intention. The system may confirm with the user by sending the user a text message. In order to assist the user for a next operation, examples by spelling inputs may be given on the user interface. In another example, the system may also confirm with the user by sending a voice message, such as the voice message “You can modify the previous content, or add a new content at the end. Which do you want?” Button options may also be given on the user interface for assistance. In some embodiments, a combination of a text message and a voice message may be given.

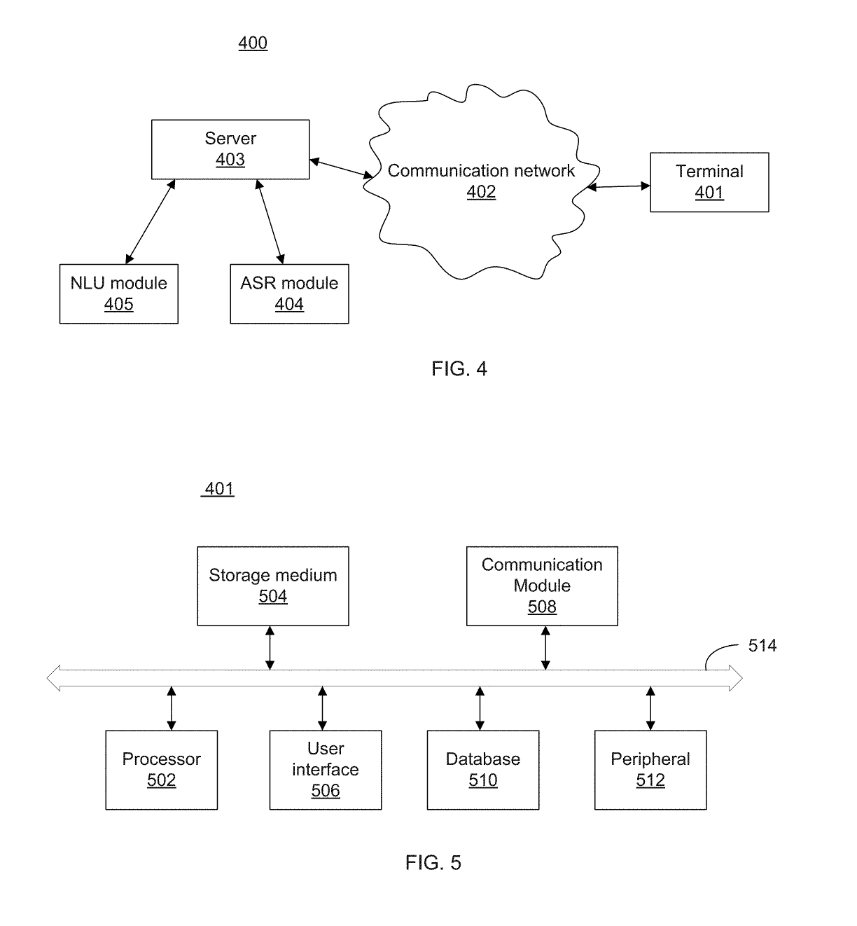

Another aspect of the present disclosure provides a system for speech recognition dictation and correction by spelling input. FIG. 4 illustrates a schematic diagram of an exemplary system which implements embodiments of the disclosed method for speech recognition dictation and correction by spelling input. As shown in FIG. 4, the system for speech recognition dictation and correction by spelling input 400 may include a terminal 401 and a server 403 in communication with the terminal 401 via a communication network 402. In some embodiments, the server 403 may include an ASR module 404 for transforming speech signals into speech recognition results, and an NLU module 405 for analyzing speech recognition results based on analytical models and/or algorithms. However, in some embodiments, the ASR module 404 and/or the NLU module 405 may be implemented at the terminal 401 for an off-line transformation and an off-line analysis.

FIG. 5 is a schematic diagram of exemplary hardware structures of a terminal according to one embodiment of the present disclosure. The server 403 of the system 400 may be implemented in a similar manner.

The terminal 401 in FIG. 5 may include a processor 502, a storage medium 504 coupled to the processor 502 for storing a computer program to be executed to carry out the claimed method, a user interface 506, a communication module 508, a database 510, a peripheral 512, and a communication bus 514. When the computer program stored in the storage medium 504 is executed, the processor 502 of the terminal 401 is configured to receive a speech signal from the user, and to instruct the communication module 508 to transmit the speech signal to the ASR module 504 via a communication bus 514. In one embodiment as shown in FIG. 4, the ASR module 404 of the server 403 is configured to process and transform the speech signal into a speech recognition result, preferably in text form. The terminal 401 obtains the speech recognition result returned from the server 403. Meanwhile, the NLU module 405 of the server 403 is configured to determine whether the speech recognition result includes the spelling input, and identify the setting according to the first speech recognition result and the speech recognition result including the spelling input. In one embodiment, the system, either by the processor 502 of the terminal 401 or by the NLU module 405 of the server 403, determines whether the speech recognition result includes the spelling input by identifying whether the speech recognition result includes the plurality of single letters. At least three settings, as shown in FIG. 1, including the correction setting (S1031), the dictation setting (S1032), and the pending setting (S1033) are identified.

In some embodiments, in response to the correction setting where the user intends to correct the previous speech recognition result, the NLU module 405 of the server 403 is configured to modify the previous speech recognition result into the edited speech recognition input. Accordingly, the edited speech recognition input is shown on the user interface 506 of the terminal 401. In one embodiment, in response to the dictation setting where the user intends for the speech recognition output, the processor 502 of the terminal 401 may be configured to show the second speech recognition result on the display unit 506. In other embodiments, in response to the pending setting, the processor 502 of the terminal 401 may be configured to send the text message and/or the voice message to confirm with the user for his/her intention.

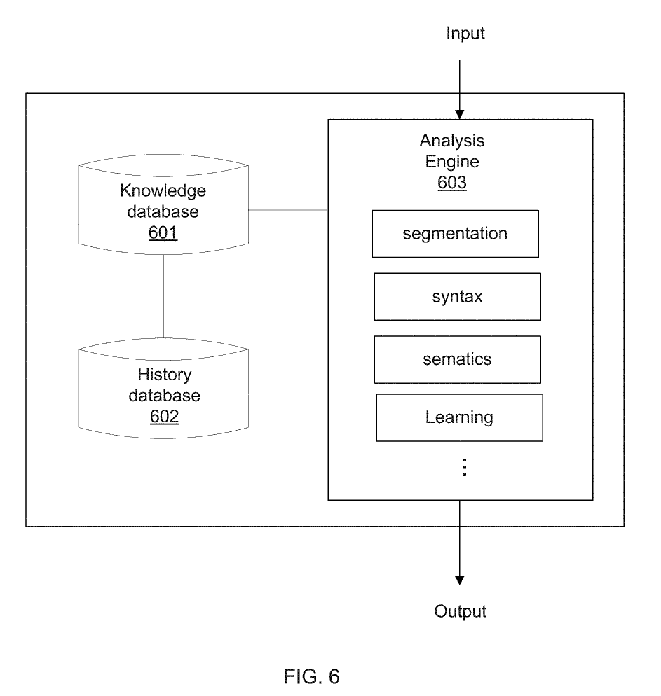

FIG. 6 is a schematic diagram of an exemplary hardware structure of a Natural Language Understanding (NLU) module. As shown in FIG. 6, in some embodiments, the NLU module may include a knowledge database 601, a history database 602, and an analysis engine 603. The knowledge database 601 may be configured to provide stored analytical models, and the analysis engine 603 may be configured to match an input with the stored analytical models. If an analytical result is found, the analysis engine 603 may output the result. The history database 602 may be configured to store historical data, based on which the analysis engine 603 may build and expand the analytical models of the knowledge database 601. The historical data herein may include previous data analyses.

Further as shown in FIG. 6, the analysis engine 603 may include a plurality of function units. In some embodiments, the function unit may include a segmentation unit, a syntax analysis unit, a semantics analysis unit, a learning unit, and the like. The analysis engine 603 may include a processor, and the processor may include, for example, a general-purpose microprocessor, an instruction-set processor and/or an associated chipset and/or a special purpose microprocessor (e.g., an application specific integrated circuit (ASIC)), and the like.

In those function units of the analysis engine 603, the segmentation unit may be configured to decompose a sentence input into a plurality of words or phrases. The syntax unit may be configured to determine properties of each element, such as subject, object, verb and the like, in the sentence input by algorithms. The semantics unit may be configured to predict and interpret a correct meaning of the sentence input through the analyses of the syntax unit. And the learning unit may be configured to train a final model based on the historical analyses.

The specific principles and implementation manners of the system provided in the embodiments of the present disclosure are similar to those in the foregoing embodiments of the disclosed method and are not described herein again.

In the present disclosure, the integrated unit implemented in the form of a software functional unit may be stored in a computer-readable storage medium. The software function unit may be stored in storage medium and includes several instructions for enabling a computer device (which may be a personal computer, a server, a network device, etc.) or a processor to execute some steps of the method according to each embodiment of the present disclosure. The foregoing storage medium includes a medium capable of storing program code, such as a USB flash disk, a removable hard disk, a read-only memory (ROM), a random access memory (RAM), a magnetic disk, an optical disc, or the like.

Another aspect of the present disclosure provides a non-transitory storage medium for storing computer-executable instructions for execution by the hardware processor 502 of the terminal 401 to receive a speech signal by the terminal 401; transmit the speech signal to the ASR module 404 of the server, and cause the ASR module 404 to transform the speech signal into a speech recognition result; cause the NLU module 405 of the server 403 to determine whether the speech recognition result includes spelling input, and to identify a setting according to a first speech recognition result and the speech recognition result including the spelling input; and in response to a correction setting in which the spelling input contains a correction content, cause the NLU module 405 to modify the first speech recognition result according to the correction content into an edited speech recognition input; and display the edited speech recognition input on the user interface 506 of the terminal 401.

The specific principles and implementation manners of the storage medium provided in the embodiments of the present disclosure are similar to those in the foregoing embodiments of the disclosed method and are not described herein again.

Those skilled in the art may clearly understand that the division of the foregoing functional modules is only used as an example for convenience. In practical applications, however, the above function allocation may be performed by different functional modules according to actual needs. That is, the internal structure of the device is divided into different functional modules to accomplish all or part of the functions described above. For the working process of the foregoing apparatus, reference may be made to the corresponding process in the foregoing method embodiments, and details are not described herein again.

It should be also noted that the foregoing embodiments are merely intended for describing the technical solutions of the present disclosure, but not to limit the present disclosure. Although the present disclosure is described in detail with reference to the foregoing embodiments, it should be understood by those of ordinary skill in the art that the technical solutions described in the foregoing embodiments may still be modified, or a part or all of the technical features may be equivalently replaced without departing from the spirit and scope of the present disclosure. As a result, these modifications or replacements do not make the essence of the corresponding technical solutions depart from the scope of the technical solutions of the present disclosure.

Other embodiments of the disclosure will be apparent to those skilled in the art from consideration of the specification and practice of the disclosure provided herein. It is intended that the specification and examples be considered as exemplary only, with a true scope and spirit of the disclosure being indicated by the claims as follows.

What is claimed is:

1. A method for speech recognition dictation and correction by spelling input, implemented in a system including a terminal, comprising:
transforming a speech signal received by the terminal into a speech recognition result;
determining whether the speech recognition result includes spelling input;
identifying a setting according to a first speech recognition result and the speech recognition result including the spelling input; and
in response to a correction setting in which the spelling input includes a correction content, modifying the first speech recognition result according to the correction content into an edited speech recognition input, and displaying the edited speech recognition input on a user interface of the terminal.

2. The method of claim 1, wherein the determining whether the speech recognition result includes the spelling input comprises: identifying whether the speech recognition result includes a plurality of single letters.

3. The method of claim 2, further comprising:
combining the plurality of single letters to form a content; and
modifying the speech recognition result according to the content into a second speech recognition result.

4. The method of claim 3, wherein the identifying the setting according to the first speech recognition result and the speech recognition result including the spelling input comprising:
comparing the first speech recognition result with the second speech recognition result; and
in response to the first speech recognition result and the second speech recognition result having a first level of overlapping in contexts, identifying the setting as the correction setting and the content as the correction content.

5. The method of claim 1, wherein the modifying the first speech recognition result according to the correction content into the edited speech recognition input, comprising:
comparing the first speech recognition result and the correction content to obtain at least one target; and
replacing the at least one target of the first speech recognition result with the correction content to form the edited speech recognition input.

6. The method of claim 3, further comprising:
in response to a dictation setting in which the spelling input includes a dictation content, displaying the second speech recognition result on the user interface of the terminal.

7. The method of claim 6, wherein the identifying the setting according to the first speech recognition result and the speech recognition result including the spelling input comprising:
comparing the first speech recognition result with the second speech recognition result; and
in response to the first speech recognition result and the second speech recognition result having a second level of non-overlapping in contexts, identifying the setting as the dictation setting and the content as the dictation content.

8. The method of claim 3, wherein the identifying the setting according to the first speech recognition result and the speech recognition result including the spelling input comprising:
comparing the first speech recognition result with the second speech recognition result based on analytical models of an Natural Language Understanding (NLU) module to obtain a first match value and a second match value;
if the first match value is greater than or equal to a first threshold, and the second match value is less than a second threshold, identifying the setting as the correction setting and the content as the correction content;
if the first match value is less than the first threshold, and the second match value is greater than or equal to the second threshold, identifying the setting as the dictation setting and the content as the dictation content;
if the first match value is greater than or equal to the first threshold, and the second match value is greater than or equal to the second threshold, identifying the setting as a pending setting; and
if the first match value is less than the first threshold, and the second match value is less than the second threshold, identifying the setting as the pending setting.

9. The method of claim 8, further comprising: sending a confirmation to a user via a text message on the user interface, a voice message through a speaker of the terminal, or a combination thereof.

10. The method of claim 9, further comprising: prompting the user to re-enter input.

11. A system for speech recognition dictation and recognition by spelling input, comprising:
a server including an Automatic Speech Recognition (ASR) module and a Natural Language Understanding (NLU) module; and
a terminal including a user interface, a processor, wherein:
the processor of the terminal is configured to receive a speech signal and transmit the speech signal to the ASR module of the server;
the ASR module is configured to transform the speech signal into a speech recognition result;
the NLU module is configured to determine whether the speech recognition result includes spelling input, and identify a setting according to a first speech recognition result and the speech recognition result including the spelling input; and
in response to a correction setting in which the spelling input includes a correction content, the NLU module is configured to modify the first speech recognition result according to the correction content into an edited speech recognition input; and the processor of the terminal is configured to display the edited speech recognition input on the user interface of the terminal.

12. The system of claim 11, wherein the NLU module is configured to identify whether the speech recognition result includes a plurality of single letters.

13. The system of claim 12, wherein the NLU module is configured to combine the plurality of single letters to form a content, and to modify the speech recognition result according to the content into a second speech recognition result.

14. The system of claim 13, wherein, in response to a dictation setting in which the spelling input includes a dictation content, the processor of the terminal is configured to display the second speech recognition result on the user interface of the terminal.

15. The system of claim 13, wherein the NLU module is configured to:
compare the first speech recognition result with the second speech recognition result based on analytical models established in the NLU module to obtain a first match value and a second match value;
if the first match value is greater than or equal to a first threshold, and the second match value is less than a second threshold, identify the setting as the correction setting and the content as the correction content;
if the first match value is less than the first threshold, and the second match value is greater than or equal to the second threshold, identify the setting as the dictation setting and the content as the dictation content;
if the first match value is greater than or equal to the first threshold, and the second match value is greater than or equal to the second threshold, identify the setting as a pending setting; and
if the first match value is less than the first threshold, and the second match value is less than the second threshold, identify the setting as the pending setting.

16. The system of claim 15, wherein the terminal further comprises a speaker, and, in response to the pending setting, the processor is configured to send a confirmation to a user via at least one of a text message on the user interface, a voice message through the speaker, and a combination thereof.

17. The system of claim 16, wherein the processor is configured to prompt the user to re-input.

18. The system of claim 11, wherein the NLU module is configured to:
compare the first speech recognition result and the correction content to obtain at least one target; and
replace the at least one target of the first speech recognition result with the correction content to form the edited speech recognition input.

19. A non-transitory storage medium for storing computer-executable instructions for execution by a hardware processor of a terminal to
receive a speech signal by the terminal;
transmit the speech signal to an Automatic Speech Recognition (ASR) module of a server, and cause the ASR module to transform the speech signal into a speech recognition result;
cause a Natural Language Understanding (NLU) module of the server to determine whether the speech recognition result includes spelling input, and to identify a setting according to a first speech recognition result and the speech recognition result including the spelling input; and
in response to a correction setting in which the spelling input includes a correction content, cause the NLU module to modify the first speech recognition result according to the correction content into an edited speech recognition input; and display the edited speech recognition input on a user interface of the terminal.

20. The non-transitory storage medium of claim 19, wherein the computer-executable instructions are executed by the hardware processor of the terminal to:
in response to a dictation setting in which the spelling input includes a dictation content, cause the NLU module to modify the speech recognition result into a modified speech recognition result according to the dictation content; and cause the processor of the terminal to display the modified speech recognition result on the user interface of the terminal.
